(19) United States
(12) Patent Application Publication
(10) Pub. No.: US 2012/0180115 A1
(43) Pub. Date: Jul. 12, 2012

(54) METHOD AND SYSTEM FOR VERIFYING A USER FOR AN ONLINE SERVICE

(76) Inventor: JOHN MAITLAND, Barrie (CA)

(21) Appl. No.: 12/986,625

(22) Filed: Jan. 7, 2011

(51) Int. Cl. H04L 9/32; G06F 21/00

(52) U.S. Cl. 726/7

(57) ABSTRACT

A system and method for verifying a user of an online or web service. According to an embodiment, a web page is provided to user for capturing an image of the user together with an embedded verification code. The captured image is provided to a verifier agent and the embedded verification code is compared to an original verification code associated with the user. If there is a match, the user is verified and an account can be created for the user. If there is no match, then the user can be rejected or the verification can be escalated to review by a supervisory agent. According to an embodiment, the embedded verification code comprises a visual representation of the code on a substrate that has been mechanically manipulated.

### FIELD OF THE INVENTION

The present invention relates to online services, and more particularly, to a method and system for verifying a user for an online or a web-based service such as a social networking, dating services, or social media.

### BACKGROUND OF THE INVENTION

Social networking and Internet based social networks or social media systems are becoming more and more popular. Membership continues to grow for the various services including online dating and match making services. With the growth and popularity of social networks or social media systems, the opportunities for misuse or malfeasance by users also tends to grow. In order to maintain the integrity of such services, the authentication or verification of users or potential users becomes a critical factor.

In view of the growth of social networks and the popularity of social networking, there remains a need for improvement in the art of authenticating or verifying users or potential users of such networks or services.

### BRIEF SUMMARY OF THE INVENTION

The present invention is directed to embodiments of a method and system for verifying a user and/or the credential(s) of a user for an online service.

According to an embodiment, the present invention provides a system for verifying the identity of a user for online service.

According to another embodiment, the present invention provides a system for verifying a credential associated with a client of a web service.

According to another embodiment, the present invention provides a method for verifying the identity of a user for online service.

According to another embodiment, the present invention provides a method for verifying a credential associated with a client of a web service.

According to one aspect or embodiment, the present invention comprises a method for verifying a user for an online service, said method comprising the steps of: providing an electronic communication to the user, said electronic communication including a link for downloading a web page for initiating a verification procedure; providing the user with a verification code for use at said web page, said verification code corresponding to an original verification code associated with the user and stored in memory; prompting the user to capture an image at said web page and said captured image including an embedded copy of said verification code; transmitting said captured image to a verifier; comparing the embedded copy of said verification code to said original verification code stored in memory; generating a verified state for the user if said verification code matches said original verification code.

According to another aspect or embodiment, the present invention comprises a system for verifying a user of an online service, said system comprising: a component configured for receiving a verification request for the user; providing a verification component for the user, said verification component being configured to initiate a verification procedure for the user; providing the user with a verification code wherein said verification code is associated with the user; said verification component being configured for capturing an image of the user and said image including an embedded copy of said verification code; said verification component being configured for transmitting said captured image and said embedded verification code to a verifier component; said verifier component being configured to compare said embedded verification code with the original verification code associated with the user, and generate a verified state for the user if said embedded verification code corresponds to said original verification code.

According to another aspect or embodiment, the present invention comprises a computer program product for performing a verification procedure for a user of a web service, said computer program product comprising: a storage medium for storing computer executable instructions, said instructions comprising, providing an electronic communication to the user, said electronic communication including a link for downloading a web page for initiating a verification procedure; providing the user with a verification code for use at said web page, said verification code corresponding to an original verification code associated with the user and stored in memory; prompting the user to capture an image at said web page and said captured image including an embedded copy of said verification code; transmitting said captured image to a verifier; comparing the embedded copy of said verification code to said original verification code stored in memory; and generating a verified state for the user if said verification code matches said original verification code.

According to another embodiment, the present invention comprises a method for verifying a user for an online service, the method comprises the steps of: providing an electronic communication to the user, the electronic communication includes a link for downloading a web page for initiating a verification procedure; providing the user with a verification code for use at the web page, the verification code corresponds to an original verification code associated with the user and stored in memory; prompting the user to capture an image at the web page and the captured image includes an embedded copy of the verification code; transmitting the captured image to a verifier; evaluating the captured image for tampering; and generating a verified state for the user if the evaluation step passes.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present invention, and in which:

FIG. 1 shows in block diagram form a system for verifying a user for an online service according to an embodiment of the present invention;

FIG. 2 shows in diagrammatic form an implementation of a verification system and method according to an embodiment of the present invention;

FIG. 3(a) is a screen shot of a landing page or window for a user verification process according to an embodiment of the present invention;

FIG. 3(b) is a screen shot of an upload photo page or window or graphical user interface screen for the for the verification process according to an embodiment of the present invention;

FIG. 3(c) is a screen shot of a Webcam image capture page or window or graphical user interface screen for the verification process according to an embodiment of the present invention;

FIG. 3(d) is a screen shot of a digital camera image capture page or window or graphical user interface screen for the verification process according to an embodiment of the present invention;

FIG. 3(e) is a screen shot of a “Process Complete” page generated according to an embodiment of the present invention;

FIG. 4 is a screen shot of a “Log in” page or window according to an embodiment of the invention;

FIGS. 5(a) to 5(d) are screen shots of pages or windows for a verifier according to an embodiment of the present invention;

FIGS. 6(a) to 6(b) are screen shots of pages or windows for a manager according to an embodiment of the present invention;

FIG. 7 is a screen shot of a page or window for an administrator according to an embodiment of the present invention; and

FIGS. 8(a) to 8(d) illustrate a flowchart showing the steps embodied in a process for verifying a user (and/or a user credential) for an online or web-based service according to an embodiment of the invention.

Like reference numerals indicate like or corresponding elements in the drawings.

### DETAILED DESCRIPTION OF THE EMBODIMENTS

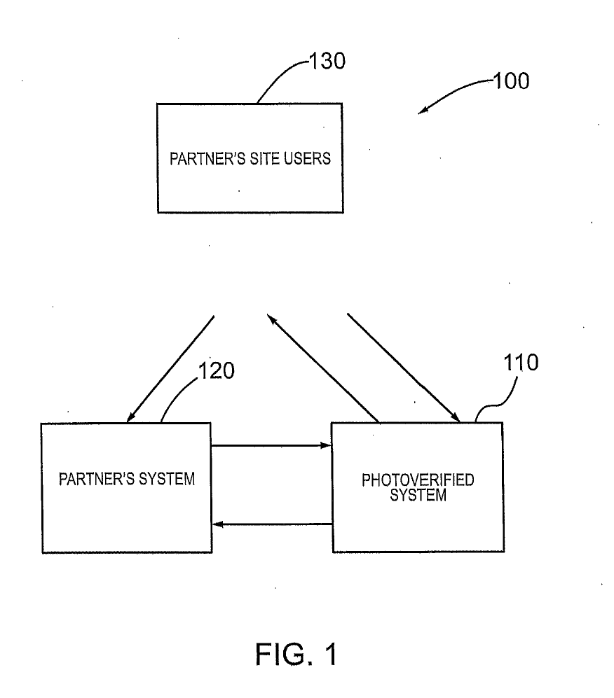

Reference is first made to FIG. 1, which shows in block diagram form a system for verifying users or potential users of an online service or network according to an embodiment of the present invention. The system is indicated generally by reference 100 and comprises a verification system or module 110, an online or web service or system 120 and users or potential users of the service indicated generally by reference 130 in FIG. 1. The online service or system 120 can comprise various web services, such as, Lava Life™, eHarmony™, Facebook™, YouTube™, Twitter™, and the like. As will be described in more detail below, the verification system or module 110 is configured to verify or authenticate the identity and/or credential(s) of a user (e.g. a new or potential subscriber or client of the web service) prior to or as condition of the user being allowed to use or participate in the online service.

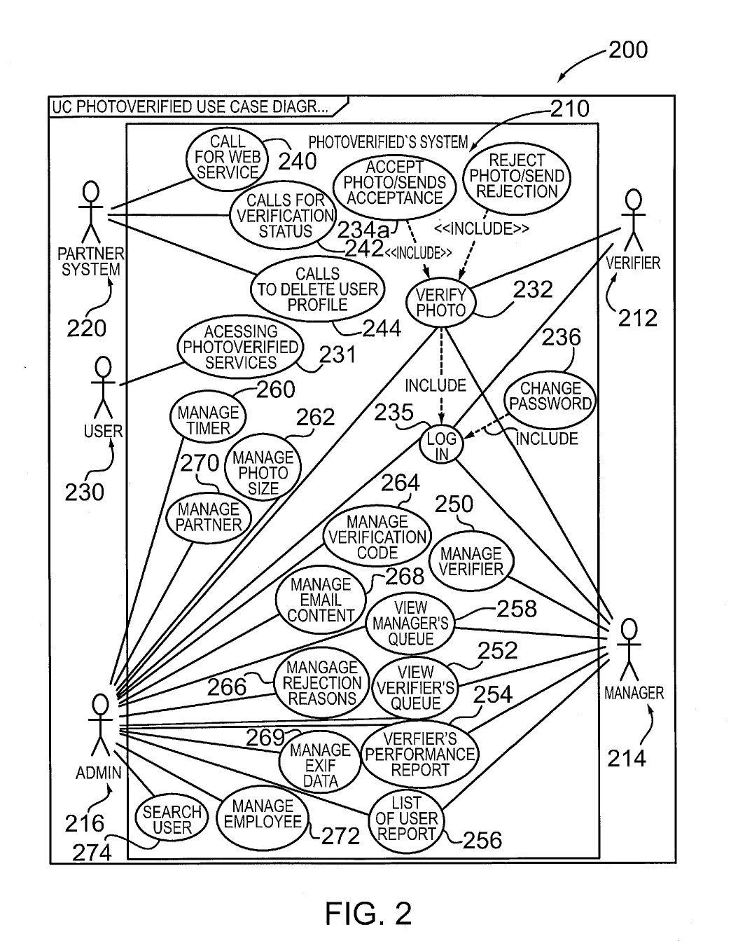

Reference is next made to FIG. 2, which shows an exemplary implementation for a verification system according to an embodiment of the present invention and indicated generally by reference 200. The exemplary system is described in the context of modules and functional elements or components comprising both hardware or system elements (e.g. computers, servers, data storage, personal or portable computing devices) and software elements or applications (e.g. computer programs, communication software, database management software or applications). It will be appreciated that the functionality and features associated with the system according to the exemplary implementation and other embodiments described herein may be implemented using executable computer software or code in the form of code objects, functional modules, components, libraries, hardware and any combinations thereof. The particular implementation details will be within the understanding of those skilled in the art.

The exemplary implementation 200 comprises a verification system 210, a partner system 220 and a user 230. The user 230 is a customer, client or member, of the partner system 220 and according to an embodiment submits photos for verification to the verification system 210. According to an embodiment, the user 230 utilizes a networked connected computer, a portable computing device or other type of communication device (for example, a mobile phone, a tablet, or digital communication device) to communicate with the verification system 210 over a network such as the Internet (World Wide Web), WAN, LAN, WIFI, or other suitable communication network, medium or protocol. The partner system 220 comprises, for example, an online service or a web service. The verification system 210 is configured to provide verification of the user 230 for the partner system 220, as will be described in more detail below. The partner system 220 is configured to engage the verification system 210, for example, to require that the user 230 be authenticated through a photo verification process as described in more detail below. According to an embodiment, the partner system 220 is configured to offer the photo verification process as an optional service to its users (i.e. members). According to an embodiment, the verification system 210 comprises a verifier 212. The verifier 212 is typically an internal employee for the verification system 210 and as will be described in more detail below is tasked with verifying profile pictures and entering codes. According to an embodiment, the verification system 210 utilizes a manager 214, who is tasked with escalation support for the verifier 212. Escalation support comprises dealing with escalation issues such as incorrect verification codes and/or questionable verification pictures. According to an embodiment, the verification system 210 can also utilize an administrator 216, who is tasked with creating the verifier(s) 212 and the manager(s) 214 on the verification system 210. The administrator 216 is also tasked with configuring functional settings for the verification system 210, including, timer, verification code(s) and maximum number of verification attempts.

As shown in FIG. 2, the partner system 220 is configured with a call for web service module 240, a call for verification status module 242 and a call to delete user profile module 244. The web service module 240 is configured to provide access to the verification system 210 as a web service, i.e. comprising one or more web pages that are accessed through the partner system 220. According to an embodiment, the partner system 220 issues a request to the verification system 210 through the web service module 240. In response to the request by the partner system 220, the verification system 210 generates an email, which is sent to the user 230 and includes a link (e.g. HTML link) to access a web page from the verification system 210 and initiate the verification procedure. According to an embodiment, the link comprises a unique link and/or a tracked link. According to another other embodiment, the user 230 is prompted or directed by the partner system 220 to access the verification system 230 or perform a verification procedure with the verification system 210. During the verification process, the user is prompted to submit one or more photos and the verifier 212 verifies one or more photographs submitted by the user 230, as indicated by reference 232, in a manner as described in more detail below. In accordance with a verification procedure, the verifier 212 accepts the submitted photo and acceptance is sent to the user 230 as indicated by functional module 234a, or the verifier 212 rejects the submitted photo and a rejection is sent to the user 230 as indicated by functional module 234b, as also described in more detail below. According to another embodiment, the system is configured to provide the verifier 212 with the option of escalating the verification procedure to a manager. According to one aspect, the escalation request comprises an escalation reason or flag, for example, in the form of a note attached to the file of the user or the user's account. The escalation reason can comprise, for example, an uncertainty in the verification that the verifier does not wish to reject outright, but instead have the manager review or further scrutinize the verification. The call for verification status module 242 is configured to request/receive the verification status associated with one or more users (e.g. members or clients of the partner system 220). The call to delete user profile module 244 is configured to request or initiate the deletion of a user from the verification system 210, for example, a user who has cancelled their membership with the partner system 220.

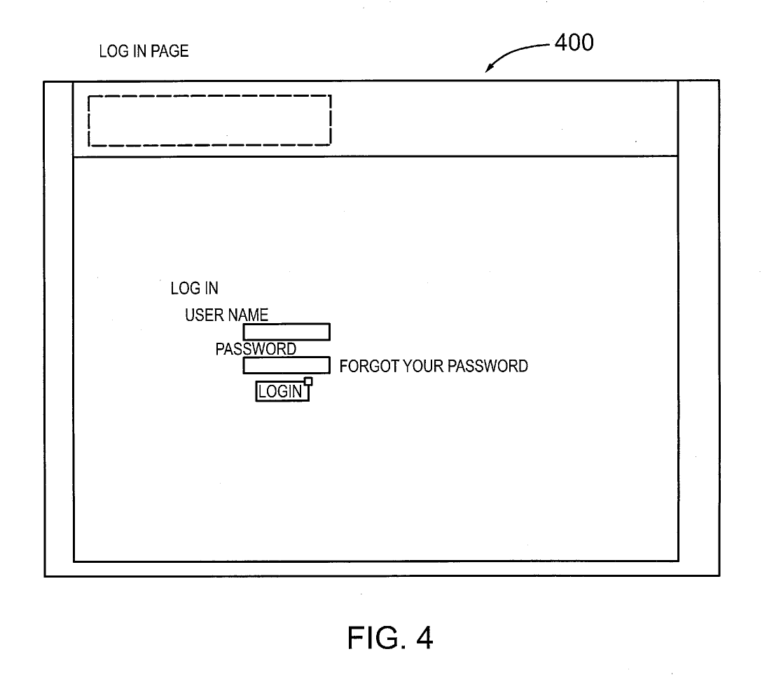

According to another aspect, the verification system 210 is configured with a log-in module 235 and a change password module 236 for logging in the verifier 212, the manager 214 and/or the administrator 216 and managing their respective credentials. The log-in module 235 can include a “Log in” page or screen as shown in FIG. 4 and indicated generally by reference 400.

As described above, the manager 214 for the verification system 210 is configured to deal with escalation issues arising from the verification process. The verification system 210 includes a manage verifier module 250, a view verifier queue module 252, a verifier performance report module 254 and a list of users report module 256. The functionality associated with these modules will be described in more detail below.

The administrator 216 as described above is tasked with creating and configuring manager and verifier roles. The administrator is also tasked with changing configurable settings for the verification system 210, including timer settings, verification code settings, photo size settings, and maximum number of attempts settings. The functionality and tasks associated with the administrator 216 are represented by or configured in a number of modules. According to an embodiment, the modules comprise executable code components or assigned tasks performed by the administrator 216. As shown in FIG. 2, the modules and tasks associated with the administrator 216 include a manage timer module 260, a manage photo size module 262, a manage verification code module 264, a manage rejection reasons module 266, a manage email content module 268, and a manage EXIF data module 269. According to an embodiment, the EXIF data comprises metadata associated with the digital images and can include ORIGIN data (e.g. author(s), date taken, program name, date acquired, copyright), IMAGE data (e.g. dimensions, width, height), CAMERA data (e.g. camera maker, camera model, f-stop, exposure time, ISO speed, exposure bias, focal length, max aperture, metering mode, flash mode) and FILE data (e.g. name, date created, date modified). According to an embodiment, the modules for the administrator 216 can also include a manage partner module 270, a manage employee module 272 and a search user module 274.

The manage timer module 260 is configured to set the timer setting (e.g. time-out) for a user to send or submit a verification photo during the verification process. The manage photo size module 262 is configured to set the maximum image size which can be uploaded to the verification system 210, for example, 4 MB. The manage verification code module 264 is configured to set or change the verification codes that are utilized in the verification process. The manage rejection reasons module 266 is configured to generate rejection reasons that are sent to a user and/or the partner system 210 through the reject photo task 234b when the verification process is not completed properly or invalid. The manage email content module 268 is configured to allow the administrator to create/edit the content of email messages that are generated by the verification system 210, such as the email including the profile link which is sent to the user to start the verification process.

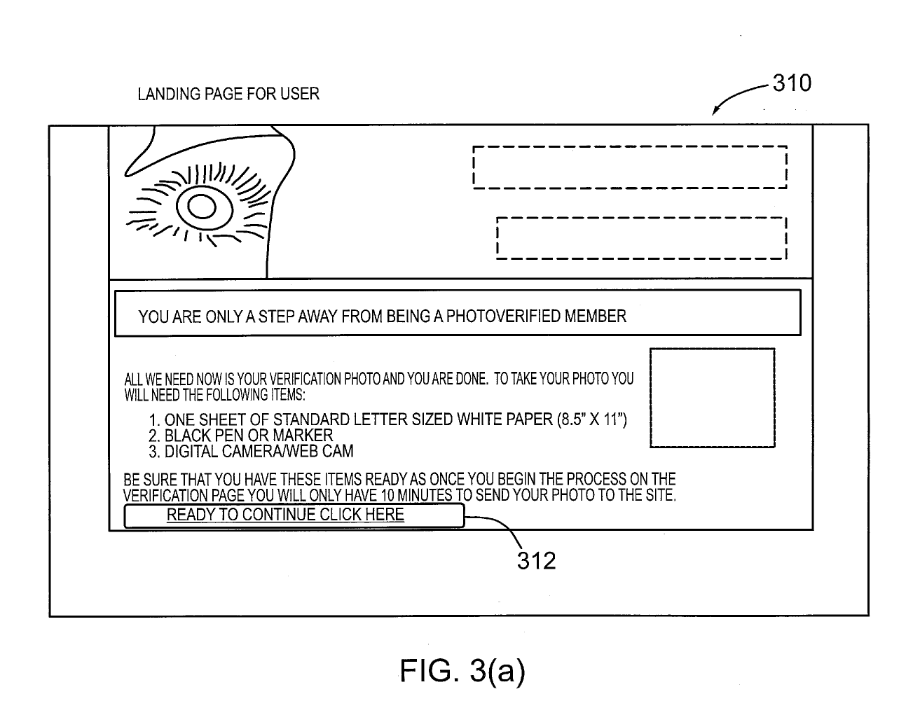

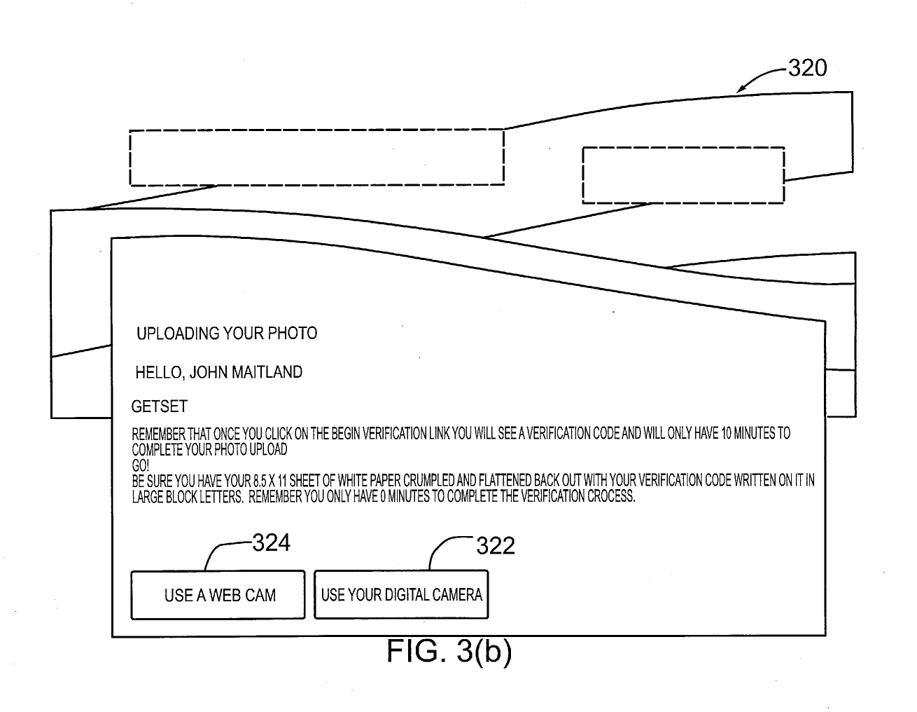

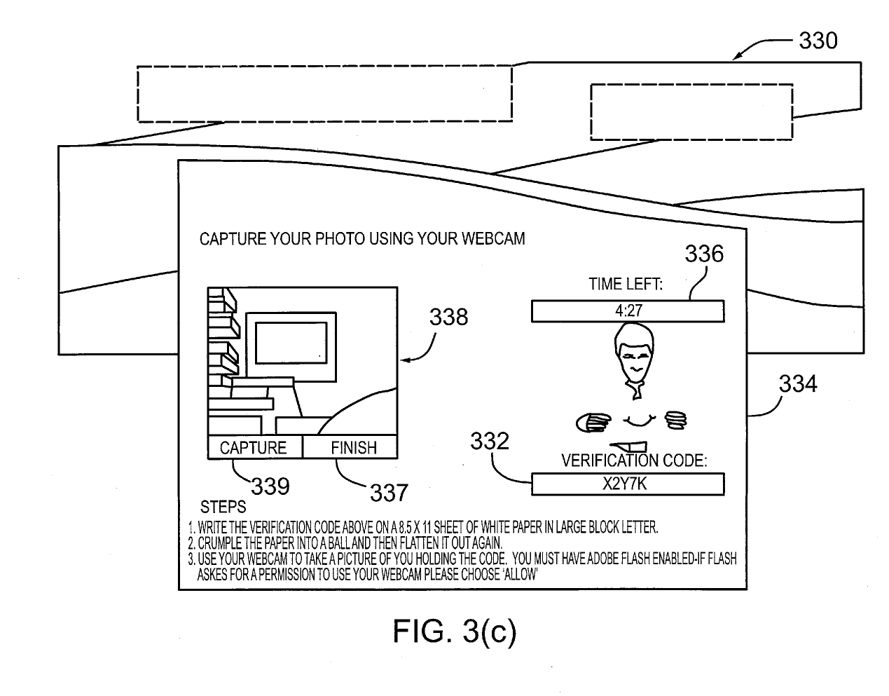

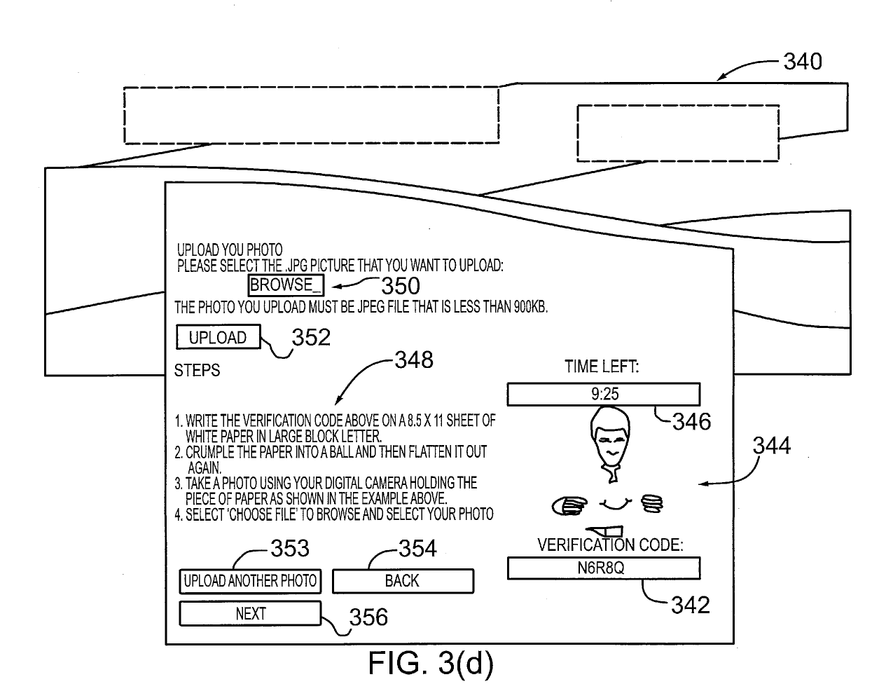

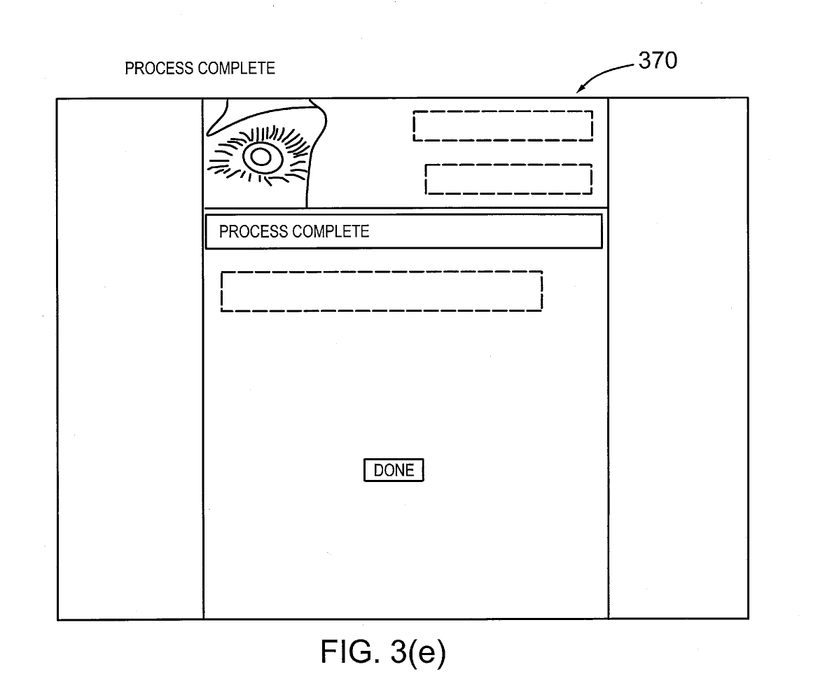

Reference is next made to FIG. 3(a) which shows a screen shot of an exemplary “landing page” for the user indicated generally by reference 310. The landing page 310 is transmitted to the user, for example, in response to the user ‘clicking’ the profile link in the email. In the context of the present description, the screen shots depict windows or screens or pages comprising web pages or other executable user interface and graphic components that are displayed on the computer device of the user (e.g. personal computer, notebook computer, tablet, mobile phone, or portable communication or computing device) and configured to provide the functionality and features as described. The particular implementation details of the “pages” will be within the understanding of one skilled in the art. As shown in FIG. 3(a), the landing page 310 includes a number of instructions or directions to the user for initiating the verification process. According to an embodiment, the user is directed to assemble the following items:

(1) a sheet of paper (i.e. standard letter sized paper)

(2) a black pen or marker

(3) a digital camera or web cam

The time-out period is shown as 10 minutes and a clickable “Ready to Continue” button 312 is provided as shown.

In response to clicking the Ready to Continue button 312, the verification system 210 displays a webpage as shown in FIG. 3(b) and indicated by reference 320. The webpage 320 is configured to allow the user to choose a webcam or a digital camera by clicking the appropriate input box or field 322 or 324. The “Use a web cam” button is configured to generate a Webcam capture page or screen as shown in FIG. 3(c) and indicated by reference 330. The “Use your digital camera” button is configured to generate a digital camera image page or screen as shown in FIG. 3(d) and indicated generally by reference 340. Once the image input device is selected, the verification system 210 generates a verification code as indicated by reference 332 in FIG. 3(c) and by reference 342 in FIG. 3(d). According to an embodiment, the verification code comprises an alpha-numeric five digit code that is generated by the verification system 210. It will be appreciated that the verification code can comprise more than (or less than) five alpha-numeric characters, or can comprise some other form of indicia in human readable and/or machine readable format, for example, graphical elements or depictions, holograms etc., or a combination of graphical elements and alpha or numeric characters.

In response to the user clicking or activating the “Use a web cam” button 324 (FIG. 3(b)), the system is configured to generate and download the Webcam capture page 330 as shown in FIG. 3(c). The verification code 332 is displayed below a illustrative box 334 and above the box 334, a “Time Left” field 336 is displayed indicating the amount of time left for the user to complete the verification process. According to an embodiment, the box 334 illustrates or depicts to the user how the image should be captured or appear. The Webcam capture page 330 is configured with an image window 338 showing the current image from the webcam connected to the user's computer. Below the image window 338 is a “Capture” button 339 and a “Finish” button 337. As shown, the user is directed to perform the following steps:

(1) write the verification code 332 on a sheet of paper

(2) crumple the sheet of paper and then flatten it out

(3) use the webcam to take a picture as shown in the image window

In response to clicking the “Capture” button 339, the verification system 210 captures the user's image and displays a freeze frame of the user's image in the image window 338 as shown in FIG. 3(c). The user can use the Capture button 339 to capture a new image or click the Finish button 337 to submit the captured image.

If the user decides to use a digital camera (instead of a Webcam), i.e. by clicking the “Use your digital camera” button 322 in FIG. 3(b), then the system is configured to generate and send the digital camera image page 340 as shown in FIG. 3(d). The digital camera image page 340 includes the verification code 342 (generated and transmitted by the system), an illustrative image box 344 and a “Time Left:” field indicated by reference 346. The “Time Left” field 346 indicates the amount of time left for the user to complete the verification process. According to an embodiment, the box 344 illustrates or depicts to the user how the image should be captured. The digital camera image page 340 also includes “Steps” indicated generally by reference 348 which comprise step-by-step instructions for using a digital camera to capture an image (or images) of the user with the verification code embedded or otherwise captured or incorporated into or associated with the image. According to an embodiment and as shown, the user is directed to perform the following steps:
(1) write the verification code (342) on a sheet of paper
(2) crumple the sheet of paper and then flatten it out (i.e. prepare or configure the substrate or carrier)
(3) take a photo using a digital camera holding the piece of page as shown in example (i.e. the illustrative box 344)
(4) use the “Browse” button to browse and select the photo
   As shown in FIG. 3(d), the digital camera image page 340 includes a Browse button and file display box 350 configured in known manner to allow the user search the user's computer or device (e.g. files, folders, mass storage) for the image(s) captured using the digital camera. Once the image file (e.g. “.jpg” picture file) is located, the user clicks an “Upload” button 352 to upload or transmit the captured image to the system for further verification. According to an embodiment, the digital camera image page 340 is configured with an “Upload another photo” button 353 and navigation controls comprising a “Back” button 354 and a “Next” button 356. The “Upload another photo” button 353 is configured to allow the user to upload another digital camera image stored on the user's device or system. According to an embodiment, the user's device comprises a mobile phone or computing device with a built-in or integrated camera and the image is captured using the built-in camera. According to an embodiment, the system can be configured to generate a “Process Complete” page, for example, as shown in the screenshot depicted in FIG. 3(e), to complete the photo submission process under the control of the user, for example, using a “Done” button.

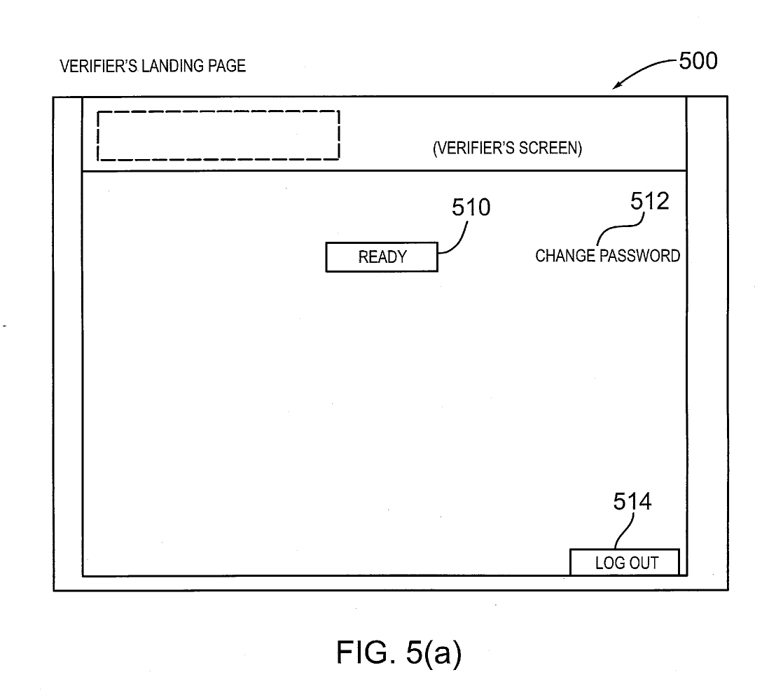

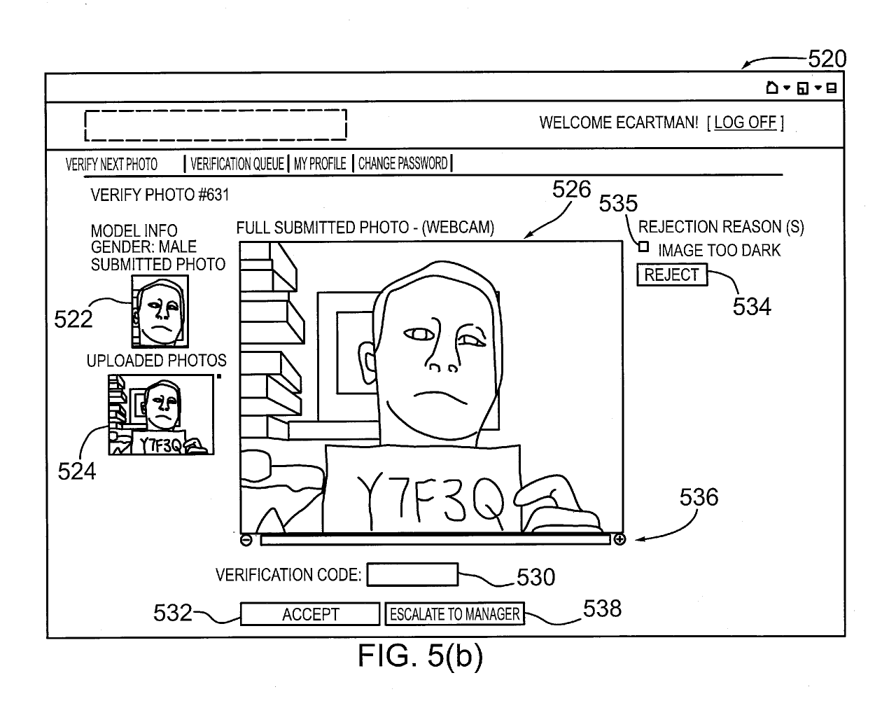

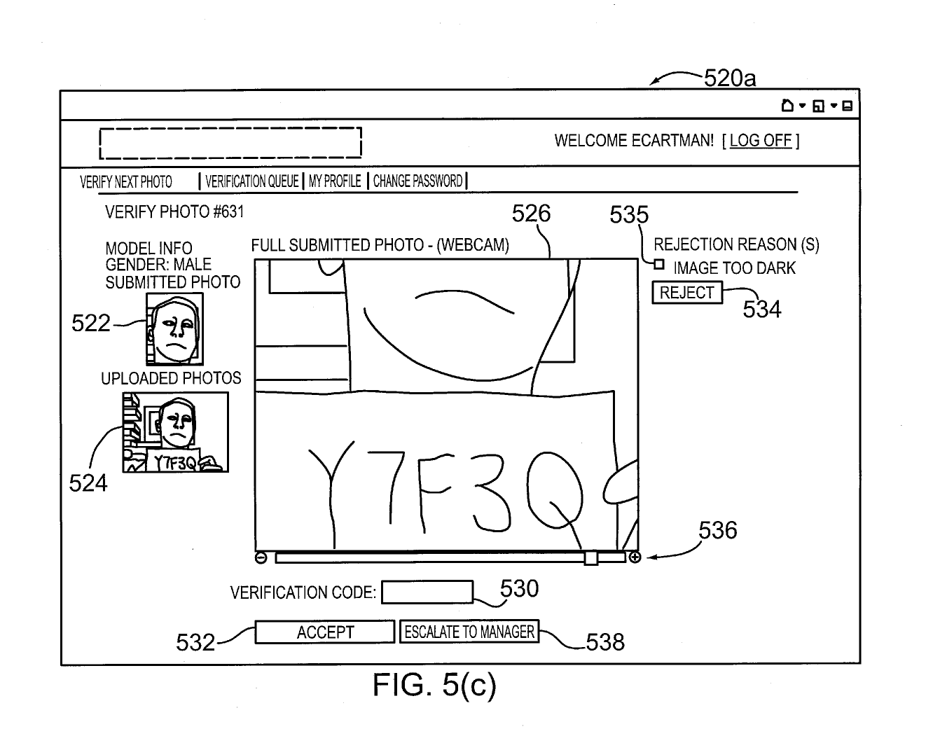

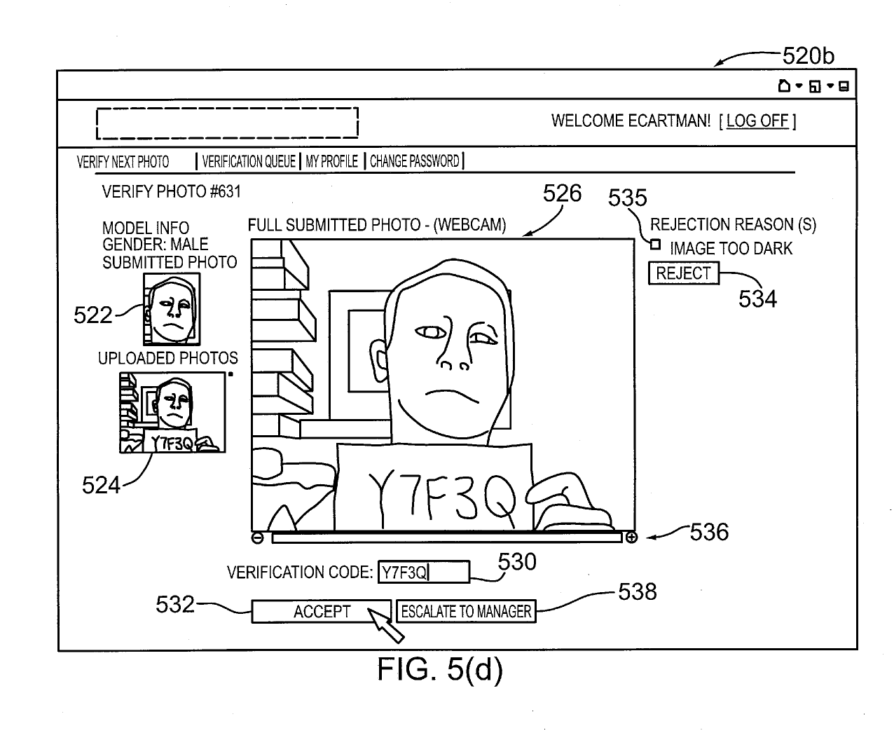

The verification process includes a second stage or step at the verification system 210 subsequent to the transmission of the user image and verification code. According to an embodiment, the verification process is completed by the verifier at the verification system 210. As described above for FIG. 4, the verifier logs onto the system and is presented with a “Verifier Landing Page” having a form as shown in FIG. 5(a) and indicated generally by reference 500. The Verifier page 500 includes a “Ready” button 510, a “Change Password” button 512 and a “Log Out” button 514. In response to clicking the Ready button 510, the system to generates/displays a “Verification Control Panel” as shown in FIG. 5(b) and indicated generally by reference 520. The Verification Control Panel 520 includes a “Submitted Photo” window 522, an “Uploaded Photos” window 524, and a “Photo Verification” window 526.

As shown in FIG. 5(b), the Photo Verification window 528 is configured to allow the verifier to verify the authenticity of the photo or image submitted by the user. The Photo Verification window 526 includes a verification code entry box 530, an “Accept” button 532, and a “Reject” button 534. According to another aspect, the Photo Verification window 526 includes a image zoom control bar 536 which is configured to enlarge/reduce the image (i.e. the uploaded photo) displayed in the verification window 526.

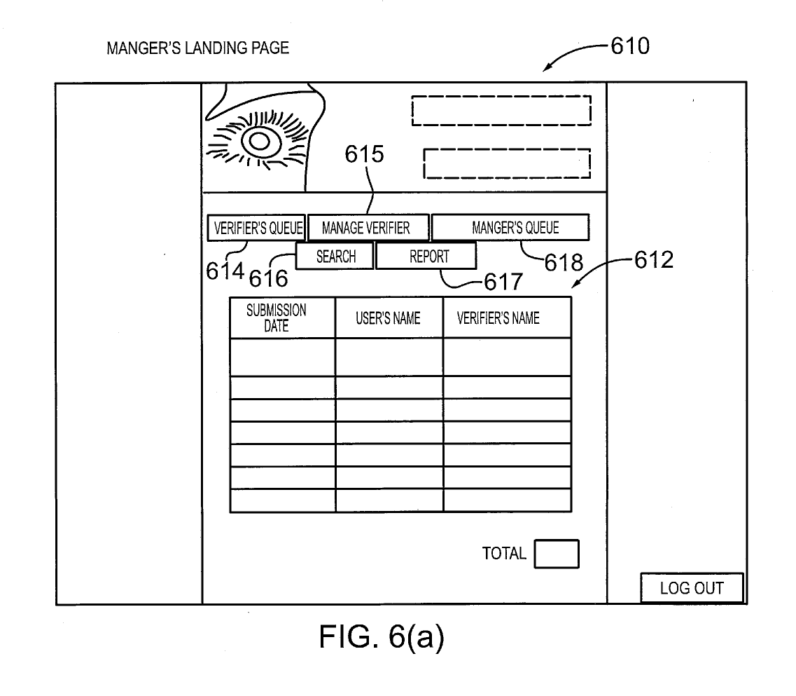

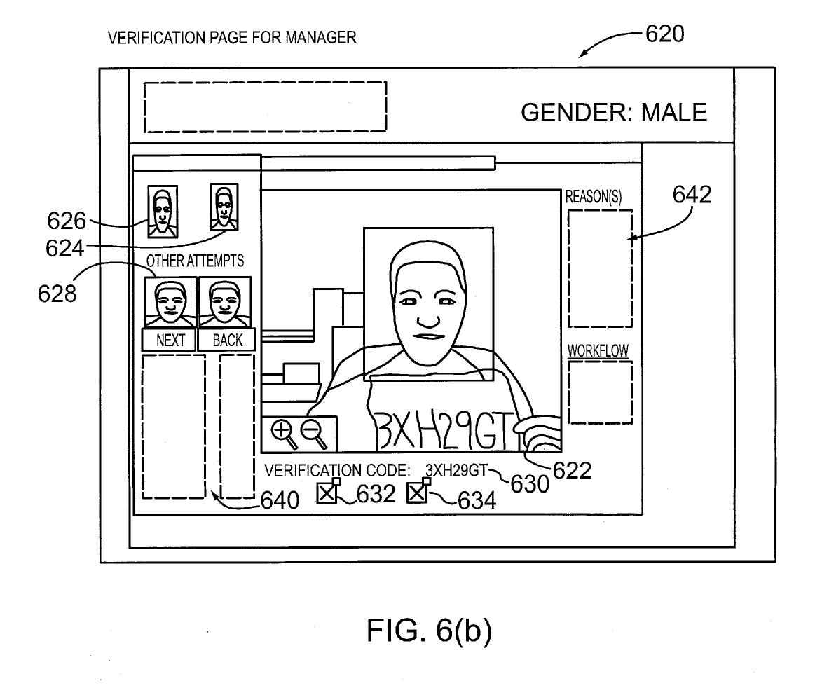

According to an embodiment, the verifier verifies the photo in the Verification window 526 and can use the zoom control bar 536 to enlarge the uploaded photo as shown in FIG. 5(c) and indicated generally by reference 520a. The zoom control 536 provides the verifier with the capability to closely inspect the verification code, the sheet of paper or carrier for verification code and also the digital image or portions of the image for any signs of tampering or digital manipulation. As described above, the paper with the code is crumpled and flattened out in order to provide a level authenticity that cannot be duplicated or generated using malicious computer software. It will be appreciated that other types of carriers or substrates can be used for the embedding an image of the verification code in the photo. For example, a substrate with unique and irreproducible indicia, such as watermarks, hologram type indicia, digital indicia, etc. Such an implementation can provide the capability to use computer image processing or other machine processing in addition to or in lieu of the visual inspection performed by the verifier. The next step (or only step according to an embodiment) in the verification process involves verifying the verification code embedded in the captured image. According to an embodiment, the verifier enters the verification code (e.g. the five digit code) embedded in the photo into the code field 530 and ‘clicks’ the “Accept” button 532 as depicted in FIG. 5(d). The verification system 210 is configured to compare the entered code with the code stored in memory for the user. If the codes match, the verification system 210 generates and sends an acceptance email to the user. The verification system 210 is also configured to save a copy of full image of the user in the Submitted Photo box 522 and a copy of the uploaded image of the user in the Uploaded Photos box 524. If the codes do not match, then according to an embodiment, the verification system 210 returns the entry to a queue for the verifier. The verifier can resubmit the code, and if the codes do not match the second time, the verification system 210 is configured to send the entry to a queue for the manager, which can be accessed from a “Landing Page” for the manager as depicted in FIG. 6(a) and indicated generally by reference 610, and the manager's queue indicated by reference 612. The verifier can also escalate the verification to the manager by clicking an “Escalate to Manager” button 538.

According to an embodiment, the Photo Verification window 526 includes a “Reject” button 534 and a “Reasons” check box 535 as shown in FIG. 5(b). The Reject button 534 and the Reasons check box 535 are configured to allow a verifier to quickly provide a reason for rejecting the user's submitted photo. The reasons for rejection can be configured by the Administrator as described above, and in this exemplary embodiment, comprise the image being too dark. If the verifier decides that the image is too dark, the check box 535 is selected and the “Reject” button 534 clicked. In response, the system 210 is configured to generate/send an automatic email to the user stating the reason(s) for rejection and the user's profile may be marked with a reject status in the database, or the automatic email can provide instructions and/or a profile link to resubmit the photo or a new photo. It will be appreciated that other reasons for rejection can be configured by or for the Administrator, and the reasons for rejection can include reasons that terminate the user's ability to use the system all the way to reasons that generate a new link or instructions for the user to re-submit a photo.

Reference is next made to FIG. 6(a) which shows the Manager's Landing page 610. As shown, the Manager's page 610 includes a Manager's queue indicated by reference 612. The Manager's page 610 also includes a “Verifier's Queue” button or active object 614, a “Manage Verifier” button 615, a “Search” button 616, a “Report” button 617 and a “Manager's Queue” button 618 for returning or displaying the Manager's Queue 612. As shown, the Manager's Queue 612 includes verification entries arranged in rows with the columns: “Submission Date”, “User's Name” and “Verifier's Name”. The verification entries are configured as active links or clickable objects, and clicking on one of the verification entries causes the system 210 to open or display a “Verification” page for manager as shown in FIG. 6(b) and indicated generally by reference 620. According to an embodiment, the Manager Verification page 620 includes a full image window 622, a cropped image window 624, a partner user image window 626 and a window for images from other attempts 628. The verification page 620 also includes a “Verification Code” field 630 (to display the final verification code) and a “Reject” button 632 and an “Approve” button 634. As shown, the verification page 620 is configured to display “EXIF DATA” 640 and the rejection “Reasons” 642 (including those checked by the verifier). As described above, the EXIF data typically comprises metadata associated with the image and the capture device (e.g. digital camera or Web cam). According to an embodiment, the manager visually inspects the full image and either approves or rejects the submission on the basis of the verification code. In response, the system 210 sends a notification (e.g. an email) to the user indicating approval or rejection and the image and associated data for the user is saved in memory (e.g. a database). Using the Reasons rejection panel 642, the manager can also reject the submission based on the rejection reasons considered by the verifier and as described above with reference to FIG. 5(b). According to another embodiment, the Manager's page 610 is configured with a workflow history mechanism that comprises a list of Verifier(s) who worked on an account and/or what status they assigned to the user account or submission.

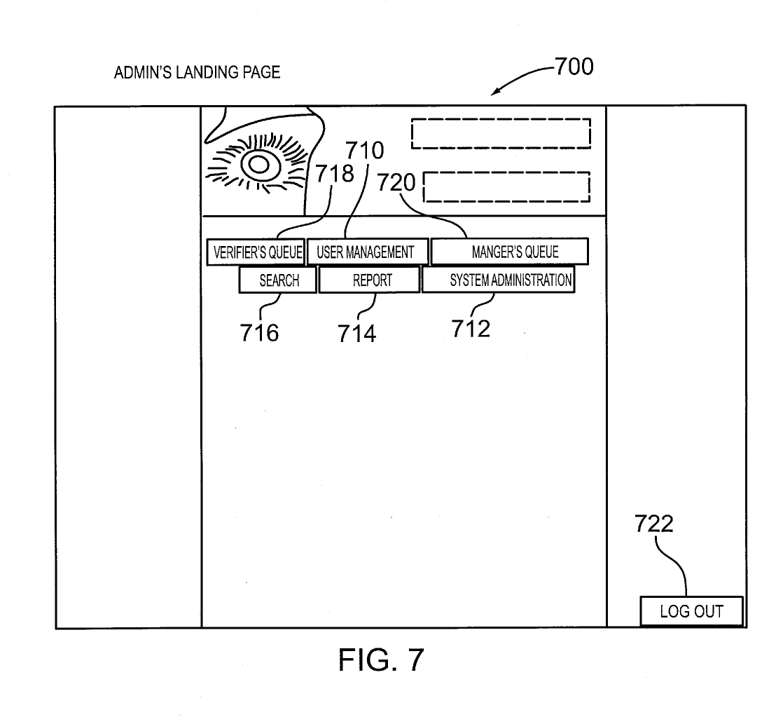

Reference is next made to FIG. 7, which shows an “Administrator's Landing” page according to an embodiment of the invention and indicated generally by reference 700. As described above with reference to FIG. 2, the administrator 216 comprises administrative and supervisory functions associated with the verification system 210, the verifier 212 and the manager 214. According to an embodiment, the Administrator's page 700 includes a “User Management” button or active object 710 for accessing a user management function and page (not shown), a “System Administration” button or active object 712 for accessing system administration functions, a “Report” button 714 for generating various types of reports associated with the verification system 210, a “Search” button to search the database(s) of the verification system 210, a “Verifier's Queue” button 718 for accessing the queue(s) for the verifier(s), and a “Manager's Queue” button 720 for accessing the manager's queue. The Administrator's page 700 is password protected and includes a “Log out” button 722 for logging out.

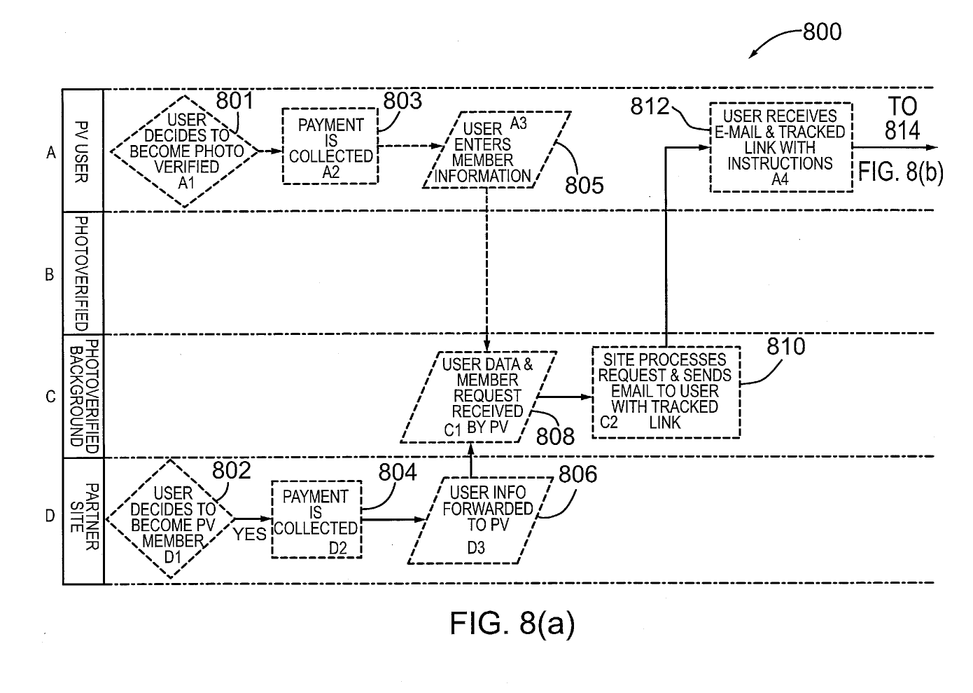

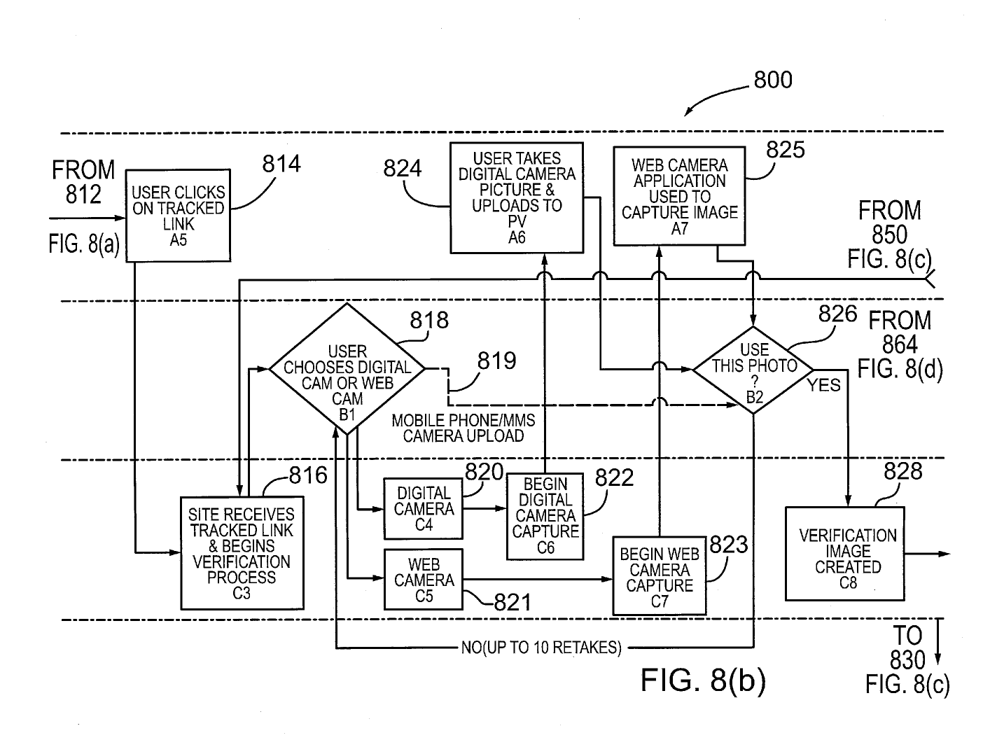

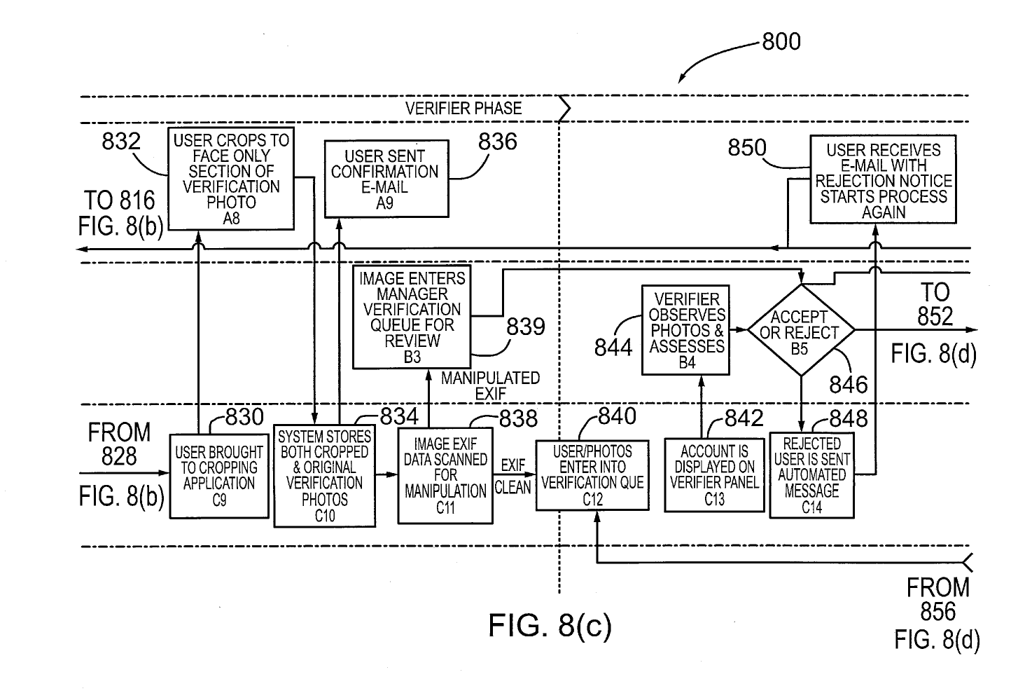

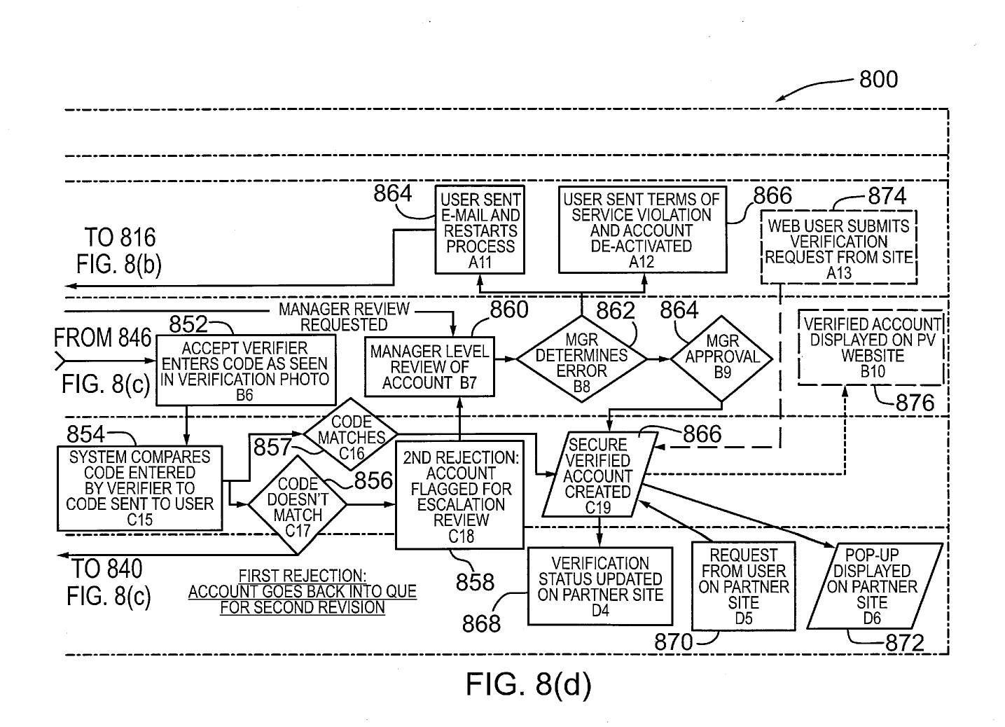

Reference is next made to FIG. 8(a) which shows in flowchart form a verification process according to an embodiment of the present invention and indicated generally by reference 800. In this exemplary embodiment, the verification process is provided by a third party and the user can access the verification service directly or as a member of a partner (e.g. a web service partnered with the verification party). The first step involves the user deciding to become a member or client of the verification service directly as indicated by block 801 or indirectly as a member of the web service as indicated by block 802. In this example, the verification is provided as a paid service, in step 804 (or step 803) payment is collected. Upon processing the payment, user information is forwarded to the verification service as indicated by block 806 (or step 805). The user information and a verification request is received by the verification service in step 808, and in response, the verification service processes the request (e.g. generating a record for the user) and generates an email or other notification, which is sent to the user and includes a profile link or other type of link to initiate the verification process, as indicated by step 810. The user receives the notification (e.g. email) and follows the instructions in step 812 and ‘clicks’ on the tracked link in step 814 (FIG. 8(b)). The verification service receives the tracked link and begins the verification process, for example, downloading a Landing page 310 as described above with reference to FIG. 3(a), as indicated by step 816. Next in step 818, the user decides between a digital camera (block 820) or a web camera (block 821), and then in step 822 captures an image using the selected device. According to another embodiment, the verification service is configured to receive or process an image upload directly from a mobile phone or MMS camera as indicated by reference 819. The image from the digital camera (or the Web cam) is uploaded to the verification service by the user as indicated in step 824 (or step 825 for the Web cam), and then in step 826 the user selects the photo for the verification process, for example, using the Choose File page 340 (FIG. 3(d)) or the Photo Select page 350 (FIG. 3(e)) as described above. In response, the verification service creates a verification image for the user as indicated in step 828. According to an embodiment, the interface (e.g. page(s)) downloaded from the verification service including a cropping function and the user stores both a cropped version of the verification photo and the original verification photo as indicated by steps 830 and 832. In step 834, the verification service stores the original verification photo (and the cropped version). Next in step 836, the verification service sends the user a confirmation email, and in step 838, EXIF data is scanned or extracted and “clean” images or photos are entered into a verification queue with the verification service as indicated by step 840. According to an embodiment, the image with EXIF data can be entered into a manager verification queue for review as indicated by step 839. This step can be initiated automatically, for example, as quality control procedure, or on a random basis. The manager verification review is described in more detail below. According to an embodiment, the clean images or photos are verified by a verifier as indicated in steps 842 to 848. According to another embodiment, the verification can be augmented or replaced by image processing and pattern recognition technology. If the image with the embedded verification code (as described above) is rejected during the verification process (step 848), for example, the image is of poor quality, the verification service sends the user an email with a rejection notice and the option to start the verification process again as indicated by step 850. If the image is of sufficient quality, the verification code embedded in the image is next verified in step 852. According to an embodiment, the verification code from the image is entered in step 852, and the verification service (i.e. the system) compares the entered code to the verification code originally sent or provided to the user, as indicated in step 854. If the verification codes match in step 857 then the user has been verified and a secure verified account is created in step 866. The creation of a secure verified account can be followed by a verification status update on the partner site or service as indicated by step 868. According to another aspect, the partner site can query the status of the secure verified account (created in step 866) as indicated by step 870 and the user account can be displayed at the partner site (for example, as pop-up) as indicated in step 872. According to another aspect, the user (e.g. a web user) can submit a verification request as indicated in step 874. According to another aspect, the verified user account is displayed or otherwise logged on the website associated with the verification service.

Reference is again made to FIG. 8(d), If the codes do not match as determined in step 856 for the first time (i.e. a first rejection), then the user's account goes back into the queue (i.e. step 840), and a second verification is performed. If the codes do not match for the second time (i.e. a second rejection) as determined in step 856, then according to an embodiment, the user account is flagged for further review (i.e. an escalation review) as indicated in step 858. According to an embodiment, the escalation review comprises a manager level review in step 860. If the manager review determines the second rejection (or escalating event) was a result of an error as determined (step 862), then the manager approves the user (step 864) and a secure verified account is created in step 866. If in step 862 the manager level review determines that the second rejection is valid, then the escalation response can comprise notifying the user and restarting the verification process (step 864). According to another embodiment, the escalation response can comprise notifying the user of a “Terms of Service” violation and deactivation of the user account as indicated in step 866.

While embodiments according to the present invention are described in the context of social networking and social media services, it will be appreciated that the embodiments have wider application to other types of networked services or configurations.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for verifying a user for an online service, said method comprising the steps of:
providing an electronic communication to the user, said electronic communication including a link for downloading a web page for initiating a verification procedure;
providing the user with a verification code for use at said web page, said verification code corresponding to an original verification code associated with the user and stored in memory;
prompting the user to capture an image at said web page and said captured image including an embedded copy of said verification code;
transmitting said captured image to a verifier;
comparing the embedded copy of said verification code to said original verification code stored in memory; and
generating a verified state for the user if said verification code matches said original verification code.

2. The method as claimed in claim 1, wherein said embedded copy of said verification code comprises a substrate carrying said verification code and said substrate being mechanically manipulated prior to capture of the image of the user and the embedded copy.

3. The method as claimed in claim 2, wherein said substrate comprises a piece of paper on which said verification code is written and said mechanical manipulation comprises crumpling and flattening said piece of paper.

4. The method as claimed in claim 1, further including the step of evaluating said captured image for tampering.

5. The method as claimed in claim 2, wherein said captured image comprises a digital image comprising metadata, and further including the step of reviewing at least some of said metadata to determine tampering with said captured image.

6. The method as claimed in claim 1, further including the step of repeating the comparison of the embedded copy of said verification code to said original code by a supervisory agent if said verifier rejects the comparison.

7. The method as claimed in claim 1, further including a supervisory agent for reviewing said captured image or said embedded copy of said verification code and said supervisory agent being responsive to a request from said verifier.

8. The method as claimed in claim 1, wherein said electronic communication to the user is initiated by the online service.

9. The method as claimed in claim 6, further including the step of creating a verified user account for the online service.

10. A system for verifying a user of an online service, said system comprising:
a component configured for receiving a verification request for the user;
providing a verification component for the user, said verification component being configured to initiate a verification procedure for the user;
providing the user with a verification code wherein said verification code is associated with the user;
said verification component being configured for capturing an image of the user and said image including an embedded copy of said verification code;
said verification component being configured for transmitting said captured image and said embedded verification code to a verifier component;
said verifier component being configured to compare said embedded verification code with the original verification code associated with the user, and generate a verified state for the user if said embedded verification code corresponds to said original verification code.

11. The system for verifying a user as claimed in claim 10, wherein said embedded verification code comprises a visual representation of said verification code captured in the image of the user.

12. The system for verifying a user as claimed in claim 11, wherein said visual representation of said verification code comprises a substrate on which the user writes the verification code and the substrate is mechanically manipulated prior to the capture of the image.

13. The system for verifying a user as claimed in claim 12, wherein said substrate comprises a sheet of paper and said mechanical manipulation comprises crumpling the sheet of paper and unfolding the sheet of paper.

14. The system for verifying as claimed in claim 10, further including a second level verifier component, said second level verifier component being responsive to a rejection of the said embedded verification code, and said second level verifier component being configured to override the rejection of the embedded verification code if said embedded verification code matches said original verification code.

15. The system as claimed in claim 14, wherein said second level verifier component is configured to be responsive to a request for verification review from said verifier component.

16. A computer program product for performing a verification procedure for a user of a web service, said computer program product comprising:
a storage medium for storing computer executable instructions, said instructions comprising,
providing an electronic communication to the user, said electronic communication including a link for downloading a web page for initiating a verification procedure;
providing the user with a verification code for use at said web page, said verification code corresponding to an original verification code associated with the user and stored in memory;
prompting the user to capture an image at said web page and said captured image including an embedded copy of said verification code;
transmitting said captured image to a verifier;
comparing the embedded copy of said verification code to said original verification code stored in memory; and
generating a verified state for the user if said verification code matches said original verification code.

17. The computer program product as claimed in claim 16, wherein said embedded copy of said verification code comprises a substrate carrying said verification code and said substrate being mechanically manipulated prior to capture of the image of the user and the embedded copy.

18. The computer program product as claimed in claim 17, wherein said substrate comprises a piece of paper on which said verification code is written and said mechanical manipulation comprises crumpling and flattening said piece of paper.

19. The computer program product as claimed in claim 16, wherein said captured image comprises a digital image comprising metadata, and further including executable instructions for evaluating at least some of said metadata to determine tampering with said captured image.

20. The computer program product as claimed in claim 16, further including executable instructions for creating a verified user account for the web service.

21. A method for verifying a user for an online service, said method comprising the steps of:
providing an electronic communication to the user, said electronic communication including a link for downloading a web page for initiating a verification procedure;
providing the user with a verification code for use at said web page, said verification code corresponding to an original verification code associated with the user and stored in memory;
prompting the user to capture an image at said web page and said captured image including an embedded copy of said verification code;
transmitting said captured image to a verifier;
evaluating said captured image for tampering; and
generating a verified state for the user if said evaluation step passes.

22. The method as claimed 21, wherein said captured image comprises a digital image comprising metadata, and further including the step of reviewing at least some of said metadata to determine tampering with said captured image.
